(19) United States
(12) Patent Application Publication
(10) Pub. No.: US 2026/0081733 A1
(43) Pub. Date: Mar. 19, 2026

(54) METHOD AND APPARATUS FOR UPLINK TRANSMISSION TIMING IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 18/775,024

(22) Filed: Jul. 17, 2024

(30) Foreign Application Priority Data
Aug. 22, 2023 (KR) 1020230109941

(51) Int. Cl. H04L 5/00; H04W 76/38

(52) U.S. Cl. CPC H04L 5/0044; H04W 76/38

(57) ABSTRACT

A method and an apparatus for managing uplink transmission timing in conjunction with LTM operations is provided. The method comprises specific set of MAC CEs to update the uplink transmission timing of a specific TAG at a specific point of time. The terminal determines the specific TAG and the specific point of time based on the type of MAC CE containing the TAC and the contents contained within the MAC CE.

### CROSS-REFERENCE TO RELATED APPLICATION

This application claims priority to and the benefit of Korean Patent Application No. 10-2023-0109941, filed on Aug. 22, 2023, the disclosure of which is hereby incorporated herein by reference in its entirety.

### BACKGROUND

### Technical Field

The present disclosure relates to performing uplink transmission timing adjustment in wireless mobile communication system.

### Related Art

To meet the increasing demand for wireless data traffic since the commercialization of 4th generation (4G communication systems), the 5th generation (5G system) is being developed. 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency.

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility.

To meet the strict service requirements for the future mobile communication system, new mobility mechanism with less interruption time is required.

### SUMMARY

Aspects of the present disclosure are to address the problems of uplink transmission timing management around LTM procedure. The method of the terminal includes receiving a radio resource control (RRC) reconfiguration message, receiving a downlink (DL) control message, performing a set of operations based on the DL control message and performing uplink transmission based on the set of operations. The set of operation comprises applying the TA command in the DL control message for a specific timing advance group (TAG) and starting a TA timer of the specific TAG. The set of operations is performed after MAC reset in case that the DL control message is LTM cell switch command MAC CE.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 1C is a diagram illustrating L1/L2 triggered mobility procedure.

FIG. 1D is a diagram illustrating update of uplink transmission timing.

FIG. 1E is a diagram illustrating timing advance group.

FIG. 2A is a diagram illustrating operations of a terminal and a base station according to an embodiment of the present invention.

FIG. 2B is a diagram illustrating format of TAC MAC CE.

FIG. 2C is a diagram illustrating format of LTM Cell Switch Command MAC CE.

FIG. 3 is a flow diagram illustrating an operation of a terminal.

FIG. 4A is a block diagram illustrating the internal structure of a UE to which the disclosure is applied.

FIG. 4B is a block diagram illustrating the configuration of a base station according to the disclosure.

### DETAILED DESCRIPTION

Hereinafter, embodiments of the present invention will be described in detail with reference to the accompanying drawings. In addition, in the description of the present invention, if it is determined that a detailed description of a related known function or configuration may unnecessarily obscure the gist of the present invention, the detailed description thereof will be omitted. In addition, the terms to be described later are terms defined in consideration of functions in the present invention, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present invention, “trigger” or “triggered” and “initiate” or “initiated” can be used interchangeably.

In the present invention, UE and terminal can be used interchangeably. In the present invention, NG-RAN node and base station and GNB can be used interchangeably.

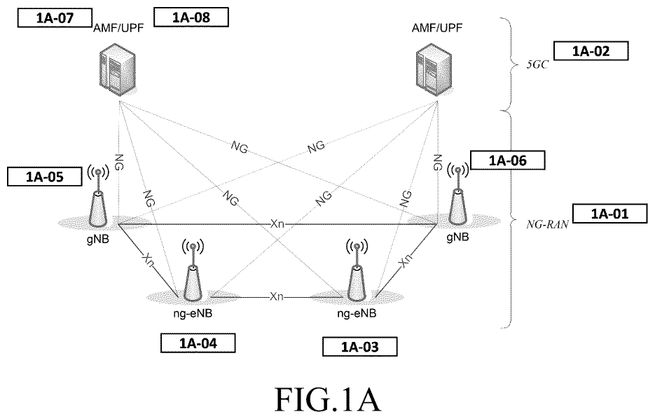

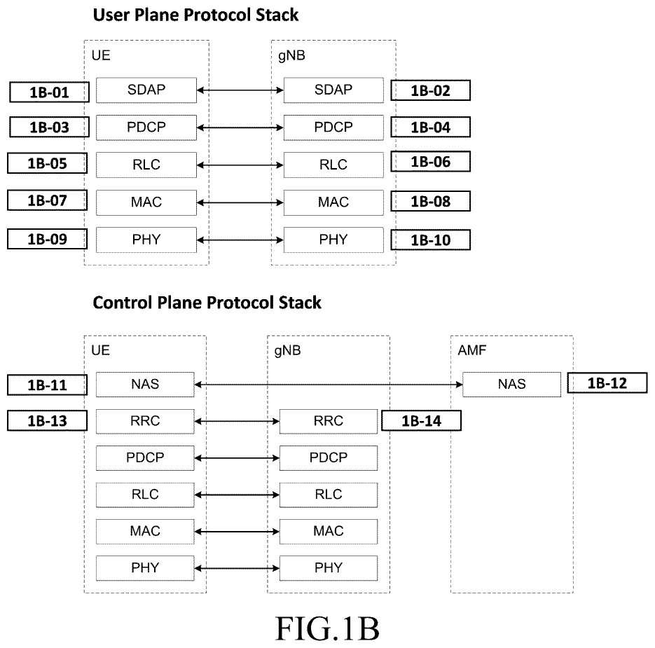

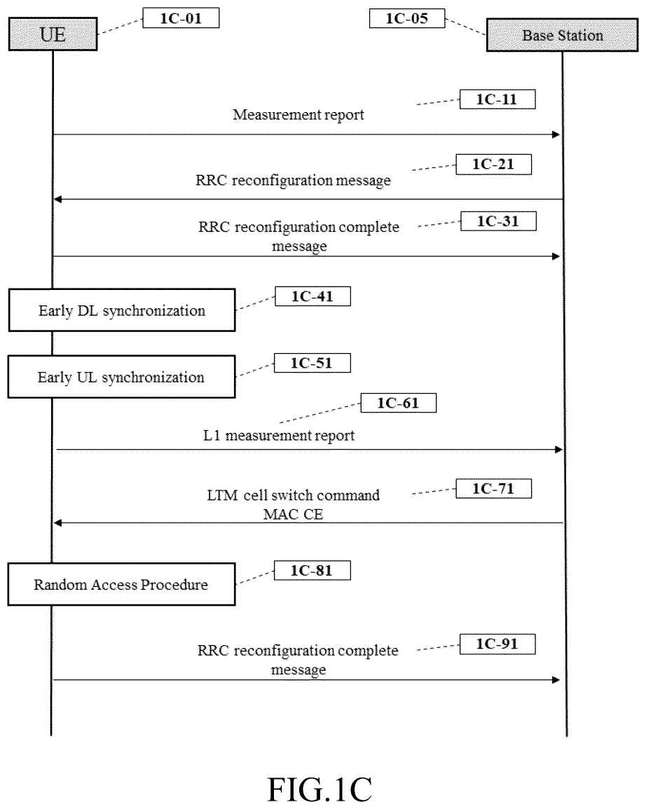

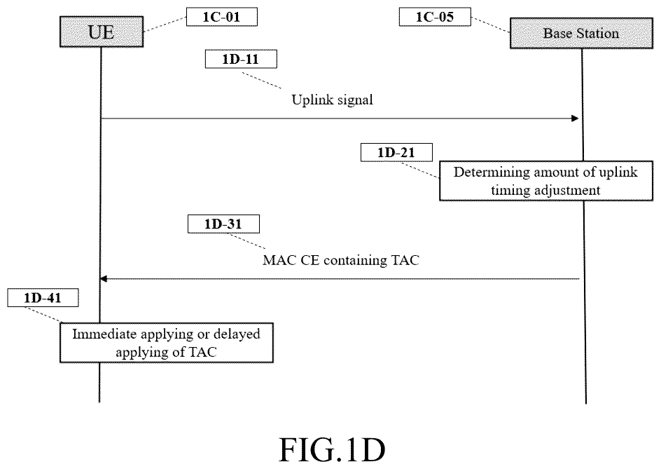

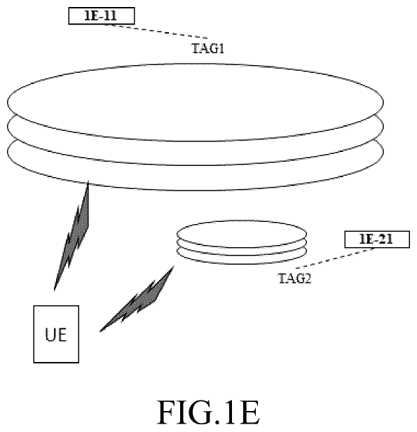

FIG. 1A is a diagram illustrating the architecture of an 5G system and a NG-RAN to which the disclosure may be applied.

5G system consists of NG-RAN 1A-01 and 5GC 1A-02. An NG-RAN node is either:
a GNB, providing NR user plane and control plane protocol terminations towards the UE; or
an ng-eNB, providing E-UTRA user plane and control plane protocol terminations towards the UE.

The GNBs 1A-05 or 1A-06 and ng-eNBs 1A-03 or 1A-04 are interconnected with each other by means of the Xn interface. The GNBs and ng-eNBs are also connected by means of the NG interfaces to the 5GC, more specifically to the AMF (Access and Mobility Management Function) and to the UPF (User Plane Function). AMF 1A-07 and UPF 1A-08 may be realized as a physical node or as separate physical nodes.

A GNB 1A-05 or 1A-06 or an ng-eNBs 1A-03 or 1A-04 hosts the functions listed below.
Functions for Radio Resource Management such as Radio Bearer Control, Radio Admission Control, Connection Mobility Control, Dynamic allocation of resources to UEs in uplink, downlink and sidelink(scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and
Radio access network sharing; and
Tight interworking between NR and E-UTRA; and
Support of Network Slicing.

The AMF 1A-07 hosts the functions such as NAS signaling, NAS signaling security, AS security control, SMF selection, Authentication, Mobility management and positioning management.

The UPF 1A-08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B-01 or 1B-02, PDCP 1B-03 or 1B-04, RLC 1B-05 or 1B-06, MAC 1B-07 or 1B-08 and PHY 1B-09 or 1B-10. Control plane protocol stack consists of NAS 1B-11 or 1B-12, RRC 1B-13 or 1B-14, PDCP, RLC, MAC and PHY.

Each protocol sublayer performs functions related to the operations listed below.
NAS: authentication, mobility management, security control etc
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

The terminal supports three RRC states.

RRC_IDLE state can be characterized with followings:
PLMN selection; Broadcast of system information;
Cell re-selection mobility;
Paging for mobile terminated data is initiated by 5GC;
DRX for CN paging configured by NAS.

RRC_INACTIVE state can be characterized with followings:
PLMN selection; Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for UE;
The UE AS context is stored in NG-RAN and the UE;
NG-RAN knows the RNA which the UE belongs to.

RRC_CONNECTED state can be characterized with followings:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Network controlled mobility including measurements.

Mobility is a key feature in mobile communications system. Conventional mobility feature relies on L3 measurements and L3 signaling, which may incur long delay and service interruption. To meet the strict service requirements for the future mobile communication system, L1/L2 Triggered Mobility (LTM) is introduced.

FIG. 1C illustrates the overall procedure for LTM.

LTM is a procedure in which a GNB receives L1 measurement report(s) from a UE, and on their basis the GNB changes UE serving cell by a cell switch command signalled via a MAC CE. The cell switch command indicates an LTM candidate configuration that the GNB previously prepared and provided to the UE through RRC signalling. Then the UE switches to the target configuration according to the cell switch command.

When configured by the network, it is possible to activate TCI states of one or multiple cells that are different from the current serving cell. For instance, the TCI states of the LTM candidate cells can be activated in advance before any of those cells become the serving cell. This allows the UE to be DL synchronized with those cells, thereby facilitating a faster cell switch to one of those cells when cell switch is triggered.

When configured by the network, it is possible to initiate UL TA acquisition (called early TA) procedure of one or multiple cells that are different from the current serving cells. If the cell has the same N_{TA} as the current serving cells or N_{TA}=0, early TA acquisition procedure is not required. The network may request the UE to perform early TA acquisition of a candidate cell before a cell switch. The early TA acquisition procedure is triggered by PDCCH order. The GNB/GNB-DU to which the candidate cell belongs calculates the TA value and sends it to the GNB/GNB-DU to which the serving cell belongs via GNB-CU. The serving cell sends the TA value in the LTM cell switch command MAC CE when triggering LTM cell switch.

Depending on the availability of a valid TA value, the UE performs either a RACH-less LTM or RACH-based LTM cell switch. If the valid TA value is provided in the cell switch command, the UE applies the TA value as instructed by the network. In the case where UE-based TA measurement is configured, but no valid TA value is provided in the cell switch command, the UE applies the valid TA value by itself if available. Meanwhile, the UE performs RACH-less LTM cell switch upon receiving the cell switch command. If no valid TA value is available, the UE performs RACH-based LTM cell switch.

Regardless of whether the UE is configured for UE-based TA measurement for a certain candidate cell, it will still follow the PDCCH order, which includes requesting a random access procedure towards the candidate cells. This also applies to the candidate cells for which the UE is capable of deriving TA values by itself. Additionally, regardless of whether the UE has already performed a random access procedure towards the candidate cells, it will still follow the UE-based measurement configuration if configured by the network.

For RACH-less LTM, the UE accesses the target cell using either a configured grant or a dynamic grant. The configured grant is provided in the LTM candidate configuration, and the UE selects the configured grant occasion associated with the beam indicated in the cell switch command. Upon initiation of LTM cell switch to the target cell, the UE starts to monitor PDCCH on the target cell for dynamic scheduling. Before RACH-less LTM procedure completion, the UE shall not trigger random access procedure if it does not have a valid PUCCH resource for triggered SRs.

The following principles apply to LTM:
Security keys are maintained upon an LTM cell switch;
Subsequent LTM is supported.

The overall procedure for LTM is as followings. Before LTM procedure is initiated, UE and GNB performs data transfer based on activated TCI states. GNB may use type 1 TCI state activation/deactivation MAC CE to activate TCI states when LTM procedure is not ongoing.

The UE sends a MeasurementReport message to the GNB. The GNB decides to configure LTM and initiates LTM preparation 1C-11.

The GNB transmits an RRCReconfiguration message to the UE including the LTM candidate configurations 1C-21.

The UE stores the LTM candidate configurations and transmits an RRCReconfigurationComplete message to the GNB 1C-31.

The UE performs early DL synchronization with the LTM candidate cell(s) before receiving the cell switch command 1C-41. The UE may activate and deactivate TCI states of LTM candidate cell(s), as triggered by the GNB. For this operation, type 2 type 2 TCI state activation/deactivation MAC CE is used. Apart from the early DL synchronization with the LTM candidate cell, GNB may use type 1 TCI state activation/deactivation MAC CE to active TCI states of serving cells.

The UE may perform early UL synchronization with LTM candidate cell(s) 1C-51 before receiving the cell switch command, by using UE-based TA measurement, if configured, and/or by transmitting a preamble towards the candidate cell, as triggered by the GNB. UE performs early TA acquisition with the candidate cell(s) as requested by the network before receiving the cell switch command.

The UE performs L1 measurements on the configured LTM candidate cell(s) and transmits L1 measurement reports to the GNB 1C-61.

The GNB decides to execute cell switch to a target cell and transmits an LTM cell switch command MAC CE 1C-71 triggering cell switch by including a target configuration ID which indicates the index of the candidate configuration of the target cell, a beam indicated with a TCI state or beams indicated with DL and UL TCI states, and a timing advance command for the target cell. The UE switches to the target cell and applies the candidate configuration indicated by the target configuration ID.

The UE performs the random access procedure towards the target cell 1C-81, if UE does not have valid TA of the target cell.

The UE completes the LTM cell switch procedure by sending RRCReconfigurationComplete message to target cell 1C-91.

Subsequent LTM is done by repeating the early synchronization, LTM cell switch execution, and LTM cell switch completion steps without releasing other LTM candidate configurations after each LTM cell switch completion.

Uplink synchronization is the process in which UE determines the exact timing for uplink transmission Usually a network (gNB) is handling multiple UEs and the network has to ensure that the uplink signal from every UE should be aligned with a common receiver timer of the network. Otherwise, interference between uplink signals from multiple UEs could degrade the reception quality of uplink signal at GNB.

Uplink synchronization is usually realized as a hand-shake process between the UE and the GNB. UE first transmits a specific uplink signal (e.g. preamble) of which transmission timing is aligned to downlink frame boundary 1D-11. GNB determines the amount of timing adjustment based on reception time of the uplink signal 1D-21. Then GNB informs the amount of adjustment via a MAC CE that contains timing advance command (TAC) 1D-31.

Upon receiving the MAC CE containing TAC, UE usually applying the TAC immediately.

However, for LTM cell switch, UE and GNB reset MAC entity before executing LTM cell switch procedure, which results in reset of TAC. Hence, UE and GNB need to distinguish the cases where the TAC needs to be applied immediately or to be applied after a specific delay 1D-41.

When TAC is applied, UE and GNB start to run time alignment timer. As long as the timer is running, UE and GNB consider uplink is synchronized and perform uplink transmission based on the current uplink timing.

Based on deployments, serving cells may require different uplink transmission timing. For example, macro cells deployed in a similar geographical area could be controlled based on a same TAC while femto cells in the geographical area should be controlled based on different TAC.

To achieve better network management and simplified UE operation, those cells requiring similar uplink transmission time treatment are grouped to together as a timing advance group (TAG).

For example, macro cells are grouped into a TAG1 1E-11 and femto cells are grouped into a different TAG2 1E-21. The TAG that contains PCell is denoted as PTAG. The TAG that contains only SCells is denoted as STAG.

TAC command may comprise information on TAG identity to which the TAC is applied.

UE applies the same TAC and the same time alignment timer for serving cells that belong to the same TAG.

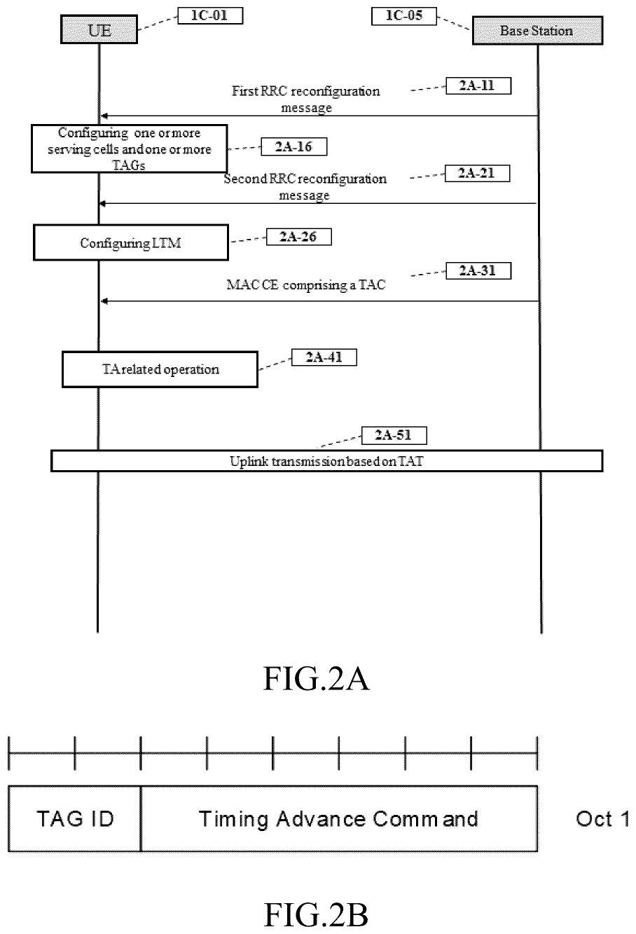

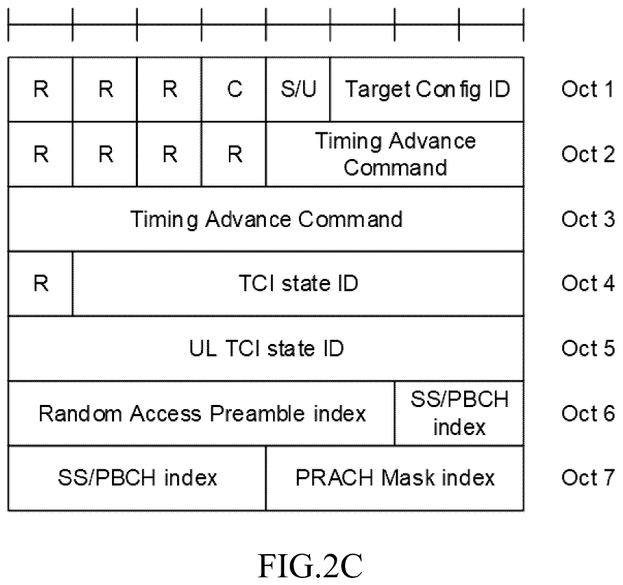

FIG. 2A illustrates operation of UE and GNB to manage uplink synchronization with regards to LTM.

UE receive a first RRCReconfiguration including a first SpCell configuration 2A-11. The RRCReconfiguration message may comprises one or more secondary cell configurations and one or more TAG configurations. The UE configures a serving special cell based on the first SpCell configuration. The UE configures one or more secondary serving cells and TAGs based on the configurations 2A-16. TAG configuration comprises TAG identity and a parameter indicating the length of the time alignment timer of the TAG. Serving cell configuration comprises serving cell identity and cell configuration (e.g. frequency information, physical cell identity, bandwidth etc) and TAG identity of which the secondary cell belongs to. The SpCell configuration comprises serving cell identity and cell configuration and TAG identity of which the SpCell belongs to and information that indicate the corresponding cell is SpCell.

UE receive a second RRCReconfiguration including one or more second SpCell configurations (each are included in a LTM candidate cell configuration) 2A-21.

UE configures LTM based on LTM candidate configuration 2A-26. LTM candidate cell configuration (or LTM candidate configuration) comprises a LTM candidate identity and a second SpCell configuration and one or more second secondary cell configurations. First SpCell configuration is a cell configuration for a serving SpCell. Second SpCell configuration is a cell configuration for a candidate SpCell. GNB may change the serving SpCell of the UE by LTM cell switch command MAC CE.

UE receives a DL control message including a Timing Advance Command (e.g. MAC CE that comprises TAC) 2A-31.

The MAC CE containing TAC could be either TAC MAC CE or LTM cell switch command MAC CE). GNB may update TAC of a TAG by transmitting TAC MAC CE before LTM cell switch occurs. GNB may cause LTM cell switch by transmitting TAC MAC CE in which TAC of PTAG is initialized for the new SpCell.

UE performs, based on the MAC CE, TA related operation 2A-41.

TA related operation comprises:
applying the Timing Advance Command indicated in the MAC CE for specific TAG; and
starting or restarting the timeAlignmentTimer for the TAG;

The UE performs with the GNB uplink transmission for the TAG based on the timeAlignmentTimer 2A-51.

If the DL control message is Timing Advance Command MAC CE:

UE may determine the specific TAG based on TAG ID in the MAC CE. UE may perform TA related operation after a first point of time. The first point of time is determined based on the slot when the MAC CE is received. timeAlignmentTimer of the TAG is indicated in the first SpCell configuration. UE determines the timeAlignmentTimer for PTAG based on the first SpCell configuration.

If the DL control message is an LTM Cell Switch Command MAC CE:

UE may determine the TAG to be PTAG. UE may perform TA related operation after a second point of time. The second point of time is when MAC entity reset due to LTM cell change occurs. imeAlignmentTimer of the TAG is indicated in a specific second SpCell configuration. The specific second SpCell configuration is determined based on Target Configuration ID (e.g. LTM-CandidateId) in the MAC CE. The specific second SpCell configuration is theSpCell configuration included in an inner RRCReconfiguration corresponding to the Target Configuration ID. UE determines the timeAlignmentTimer for PTAG based on the specific second SpCell configuration.

SpCell configuration includes a timeAlignmentTimer.

During the LTM cell switch procedure, a supervision timer (e.g. timer for procedure triggered by the MAC CE) is running. If the timer expires before the procedure successfully completed, UE consider the procedure failed and takes a proper measure for recovery.

In relation with the supervision timer, UE operates as below to manage the time alignment timer.

UE receives a first RRCReconfiguration including one or more LTM candidate cell configuration and L1 measurement report configuration. Each of the LTM candidate cell configuration comprises a parameter for a timer for a supervision timer.

UE receives a LTM Cell Switch Command MAC CE.

UE starts the supervision timer corresponding to the target LTM candidate cell configuration.

UE resets MAC entity of the cell group.

UE starts the timeAlignmentTimer for the PTAG.

UE stops the supervision timer when the procedure successfully completed. UE consider the procedure successfully completed when the UE determines that the network has successfully received its first UL data (e.g. when UE receives uplink grant for new transmission for a HARQ process that was used for the first UL data).

UE performs uplink transmission based on that the timeAlignmentTimer for the PTAG being running.

When the timer expires, UE stops the timeAlignmentTimer and initiates recovery procedure (e.g. RRC connection reestablishment).

LTM candidate cell configuration (e.g. LTM-CandidateToAddMod) includes following IEs/fields.
LTM-CandidateId IE.
ltm-CandidateConfig field that includes an inner RRCReconfiguration; The inner RRCReconfiguration includes:
   SpCellConfig; and
   one or more ScellConfig.
one or more CandidateTCI-StatesToAddMod

MAC reset is a set of operations to initialize the MAC entity upon specific set of events such as mobility or failure recovery.

In general, UE performs MAC reset before the first uplink transmission in the target cell. In addition, UE should perform MAC reset before applying the TAC for the target cell. Otherwise, the applied TAC is initialized again by MAC reset.

When MAC reset occurs, UE may:
initialize Bj for each logical channel to zero;
stop (if running) all timers, except MBS broadcast DRX timers;
consider all timeAlignmentTimers, inactivePosSRS-TimeAlignmentTimer, and cg-SDT-TimeAlignmentTimer, if configured, as expired.
set the NDIs for all uplink HARQ processes to the value 0;
stop, if any, ongoing Random Access procedure;
flush Msg3 buffer;
flush MSGA buffer;
cancel, if any, triggered Scheduling Request procedure;
cancel, if any, triggered Buffer Status Reporting procedure;
cancel, if any, triggered Delay Status Reporting procedure;
cancel, if any, triggered Power Headroom Reporting procedure;
cancel, if any, triggered BFR;
cancel, if any, triggered Timing Advance Reporting procedure;
cancel, if any, triggered Configured uplink grant confirmation;
cancel, if any, triggered SDT procedure;
flush the soft buffers for all DL HARQ processes, except for the DL HARQ process being used for MBS broadcast;
for each DL HARQ process, except for the DL HARQ process being used for MBS broadcast, consider the next received transmission for a TB as the very first transmission;

### Release, If Any, Temporary C-RNTI.

FIG. 2B illustrates format of the Timing Advance Command MAC CE.

The type 1 TCI state activation/deactivation MAC CE comprises following fields:
TAG Identity (TAG ID): This field indicates the TAG Identity of the addressed TAG. The TAG with the Identity 0 contains the SpCell. The length of the field is 2 bits;
Timing Advance Command: This field indicates the index value TA (0, 1, 2 . . . 63) used to control the amount of timing adjustment that MAC entity has to apply.

FIG. 2C illustrates format of LTM Cell switch command MAC CE.
Target Configuration ID: This field indicates the index of candidate target configuration to apply for LTM cell switch, corresponding to ltm-CandidateId.
Timing Advance Command: This field indicates whether the TA is valid for the LTM target cell (i.e. the SpCell corresponding to the target configuration indicated by Target Configuration ID field). If the value of this field is set to FFF, this field indicates that no valid timing adjustment is available for the PTAG of the LTM target cell (and UE shall perform Random Access to the LTM target cell); Otherwise, this field indicates the index value TA used to control the amount of timing adjustment that the MAC entity has to apply, and that the UE can skip the Random Access procedure for this LTM cell switch.
TCI state ID: This field indicates and activates the TCI state for the LTM target cell (i.e. the SpCell of the target configuration indicated by the Target Configuration ID field). The TCI state is identified by TCI-StateId. If the value of unifiedTCI-StateType in the SpCell of the target configuration indicated by Target Configuration ID field is joint, this field is for joint TCI state, otherwise, this field is for downlink TCI state. This field is included when the value of the Timing Advance Command field is not set to FFF.
UL TCI state ID: This field indicates and activates the uplink TCI state for the LTM target cell (i.e. the SpCell of the target configuration indicated by the Target Configuration ID field). The most significant bits of UL TCI state ID are considered as reserved bits and the remainder 6 bits indicate the TCI-UL-StateId. This field is included if the value of unifiedTCI-StateType in the SpCell corresponding to the target configuration indicated by Target Configuration ID field is separate and if the value of the Timing Advance Command field is not set to FFF.

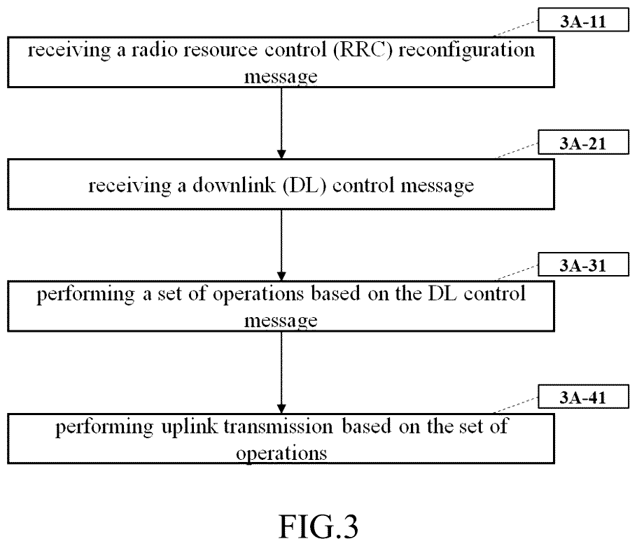

FIG. 3 illustrates UE operations.

UE performs followings:
receiving a radio resource control (RRC) reconfiguration message 3A-11, wherein the RRC reconfiguration message comprises one or more candidate configurations;
receiving a downlink (DL) control message 3A-21, wherein the DL control message comprises a timing advance (TA) command;
performing a set of operations based on the DL control message 3A-31;
performing uplink transmission based on the set of operations 3A-41.

The set of operations comprises:
applying the TA command in the DL control message for a specific timing advance group (TAG); and
starting a TA timer of the specific TAG,

In case that the DL control message is a lower layer triggered mobility (LTM) cell switch command medium access control (MAC) control element (CE):
the set of operations is performed at a first point of time;
the specific TAG is primary TAG;
the first point of time is determined based on a MAC reset; and
the MAC reset is performed due to the LTM cell switch command MAC CE.

In case that the DL control message is a timing advance command (TAC) MAC CE:
the set of operation is performed at a second point of time;
the specific TAG is indicated in the TAC MAC CE; and
the second point of time is determined based on reception of the TAC MAC CE

Each of the one or more candidate configurations comprises:
a candidate identifier;
a special cell configuration; and
one or more secondary cell configurations.

Length of the TA timer is determined based on a specific candidate configuration and the specific candidate configuration is determined based on target configuration identity field in the LTM cell switch command MAC CE.

Length of the TA timer is determined based on a second RRC reconfiguration message and the terminal receives the second RRC reconfiguration message before the RRC reconfiguration message.

The LTM cell switch command MAC CE comprises:
a target configuration identity field;
a TA command field; and
a TCI state identity field.

In case that the TA command field indicates a specific value, the terminal does not perform the set of operations and performs random access procedure.

TCI state indicated by the TCI state identity field is applied to initial uplink transmission toward a candidate cell.

The candidate cell is determined based on the target configuration identity field.

The TAC MAC CE comprises a TAG identity field and a TA command field.

UE performs followings:
receiving by the terminal a first radio resource control (RRC) reconfiguration message, wherein the RRC reconfiguration message comprises one or more candidate configurations;
receiving by the terminal a lower layer triggered mobility (LTM) cell switch command MAC CE;
starting by the terminal a timer related to LTM cell switch procedure;
starting by the terminal a timer related to uplink transmission for a specific TAG based on a specific candidate configuration;
stopping by the terminal the timer related to LTM cell switch procedure in case that LTM cell switch procedure is successfully completed; and
performing by the terminal uplink transmission based on the timer related to uplink transmission.

The timer related to LTM cell switch procedure starts before a MAC reset. The timer related to uplink transmission starts after the MAC reset. The MAC reset is triggered in response to reception of the LTM cell switch procedure.

The terminal stops the timer related to uplink transmission in case that the timer related to LTM cell switch procedure expires.

The terminal stops uplink transmission in case that the timer related to uplink transmission stops.

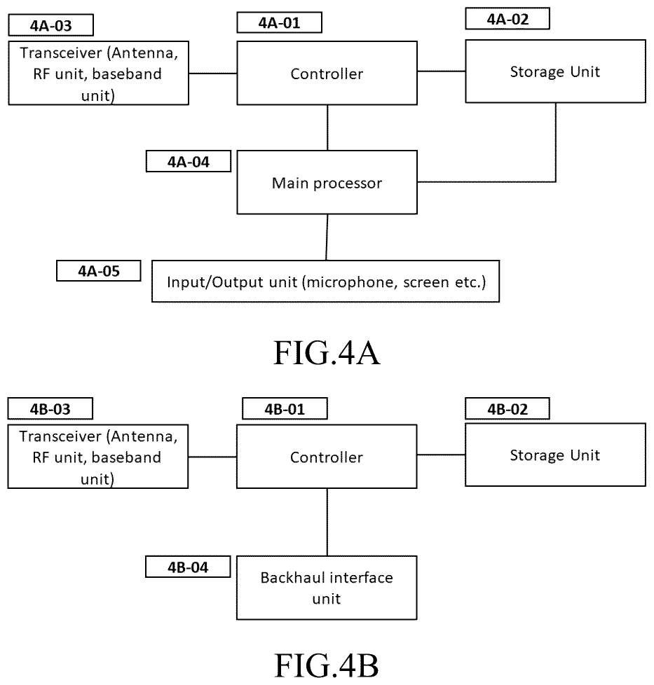

FIG. 4A is a block diagram illustrating the internal structure of a UE to which the disclosure is applied.

Referring to the diagram, the UE includes a controller 4A-01, a storage unit 4A-02, a transceiver 4A-03, a main processor 4A-04 and I/O unit 4A-05.

The controller 4A-01 controls the overall operations of the UE in terms of mobile communication. For example, the controller 4A-01 receives/transmits signals through the transceiver 4A-03. In addition, the controller 4A-01 records and reads data in the storage unit 4A-02. To this end, the controller 4A-01 includes at least one processor. For example, the controller 4A-01 may include a communication processor (CP) that performs control for communication and an application processor (AP) that controls the upper layer, such as an application program. The controller controls storage unit and transceiver such that UE operations illustrated in FIG. 2A and FIG. 3 are performed.

The storage unit 4A-02 stores data for operation of the UE, such as a basic program, an application program, and configuration information. The storage unit 4A-02 provides stored data at a request of the controller 4A-01.

The transceiver 4A-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 4A-04 controls the overall operations other than mobile operation. The main processor 4A-04 process user input received from I/O unit 4A-05, stores data in the storage unit 4A-02, controls the controller 4A-01 for required mobile communication operations and forward user data to I/O unit 4A-05.

I/O unit 4A-05 consists of equipment for inputting user data and for outputting user data such as a microphone and a screen. I/O unit 4A-05 performs inputting and outputting user data based on the main processor's instruction.

FIG. 4B is a block diagram illustrating the configuration of a base station according to the disclosure.

As illustrated in the diagram, the base station includes a controller 4B-01, a storage unit 4B-02, a transceiver 4B-03 and a backhaul interface unit 4B-04.

The controller 4B-01 controls the overall operations of the main base station. For example, the controller 4B-01 receives/transmits signals through the transceiver 4B-03, or through the backhaul interface unit 4B-04. In addition, the controller 4B-01 records and reads data in the storage unit 4B-02. To this end, the controller 4B-01 may include at least one processor. The controller controls transceiver, storage unit and backhaul interface such that base station operation illustrated in FIG. 2A are performed.

The storage unit 4B-02 stores data for operation of the main base station, such as a basic program, an application program, and configuration information. Particularly, the storage unit 4B-02 may store information regarding a bearer allocated to an accessed UE, a measurement result reported from the accessed UE, and the like. In addition, the storage unit 4B-02 may store information serving as a criterion to deter mine whether to provide the UE with multi-connection or to discontinue the same. In addition, the storage unit 4B-02 provides stored data at a request of the controller 4B-01.

The transceiver 4B-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 4B-04 provides an interface for communicating with other nodes inside the network. The backhaul interface unit 4B-04 converts a bit string transmitted from the base station to another node, for example, another base station or a core network, into a physical signal, and converts a physical signal received from the other node into a bit string.

What is claimed is:

1. A method by a terminal, the method comprising:
receiving by the terminal a radio resource control (RRC) reconfiguration message, wherein the RRC reconfiguration message comprises one or more candidate configurations;
receiving by the terminal a downlink (DL) control message, wherein the DL control message comprises a timing advance (TA) command;
performing by the terminal a set of operations based on the DL control message; and
performing by the terminal uplink transmission based on the set of operations,
wherein the set of operation comprises:
applying the TA command in the DL control message for a specific timing advance group (TAG); and
starting a TA timer of the specific TAG, and
wherein, in case that the DL control message is a lower layer triggered mobility (LTM) cell switch command medium access control (MAC) control element (CE):
the set of operation is performed at a first point of time;
the specific TAG is primary TAG; and
the first point of time is determined based on MAC reset.

2. The method of claim 1,
wherein in case that the DL control message is a timing advance command (TAC) MAC CE:
the set of operation is performed at a second point of time;
the specific TAG is indicated in the TAC MAC CE; and
the second point of time is determined based on reception of the TAC MAC CE.

3. The method of claim 1,
wherein each of the one or more candidate configurations comprises:
a candidate identifier;
a special cell configuration; and
one or more secondary cell configurations.

4. The method of claim 1, wherein:
length of the TA timer is determined based on a specific candidate configuration; and
the specific candidate configuration is determined based on target configuration identity field in the LTM cell switch command MAC CE.

5. The method of claim 1, wherein:
length of the TA timer is determined based on a second RRC reconfiguration message; and
the terminal receives the second RRC reconfiguration message before the RRC reconfiguration message.

6. The method of claim 1,
wherein the LTM cell switch command MAC CE comprises:
a target configuration identity field;
a TA command field; and
a TCI state identity field.

7. The method of claim 6,
wherein, in case that the TA command field indicates a specific value, the terminal:
does not perform the set of operations; and
performs random access procedure.

8. The method of claim 6,
wherein TCI state indicated by the TCI state identity field is applied to initial uplink transmission toward a candidate cell.

9. The method of claim 8,
wherein the candidate cell is determined based on the target configuration identity field.

10. The method of claim 2,
wherein the TAC MAC CE comprises:
a TAG identity field; and
a TA command field.

11. A method by a terminal, the method comprising:
receiving by the terminal a first radio resource control (RRC) reconfiguration message, wherein the RRC reconfiguration message comprises one or more candidate configurations;
receiving by the terminal a lower layer triggered mobility (LTM) cell switch command medium access control (MAC) control element (CE);
starting by the terminal a timer related to LTM cell switch procedure;
starting by the terminal a timer related to uplink transmission for a specific timing advance group (TAG) based on a specific candidate configuration;
stopping by the terminal the timer related to LTM cell switch procedure in case that the LTM cell switch procedure is successfully completed; and
performing by the terminal uplink transmission based on the timer related to uplink transmission,
wherein:
the timer related to LTM cell switch procedure starts before a MAC reset;
the timer related to uplink transmission starts after the MAC reset; and
the MAC reset is triggered in response to reception of the LTM cell switch procedure.

12. The method of the claim 11,
wherein the terminal stops the timer related to uplink transmission in case that the timer related to LTM cell switch procedure expires.

13. The method of claim 12,
wherein the terminal stops uplink transmission in case that the timer related to uplink transmission stops.

14. A terminal comprising:
a transceiver,
a memory, and
a controller coupled to the transceiver and the memory, wherein the controller is configured to cause the terminal to:
receive a radio resource control (RRC) reconfiguration message, wherein the RRC reconfiguration message comprises one or more candidate configurations;
receive a downlink (DL) control message, wherein the DL control message comprises a timing advance (TA) command;
perform a set of operations based on the DL control message; and
perform uplink transmission based on the set of operations,
wherein the set of operation comprises:
applying the TA command in the DL control message for a specific timing advance group (TAG); and
starting a TA timer of the specific TAG, and
wherein, in case that the DL control message is a lower layer triggered mobility (LTM) cell switch command medium access control (MAC) control element (CE):
the set of operation is performed at a first point of time;
the specific TAG is primary TAG; and
the first point of time is determined based on MAC reset.
